(19) United States
(12) Patent Application Publication
(10) Pub. No.: US 2016/0042455 A1
(43) Pub. Date: Feb. 11, 2016

(54) PERFORMANCE EVALUATION OF TRADING STRATEGIES

(71) Applicants: Sunil Arvindam, Bangalore (IN); Gaurav Chadha, Delhi (IN); Ashok Veilumuthu, Tirunelveli (IN); Suresh Venkatasubramaniyan, Madurai/Tamilnadu (IN); Nischal HP, Bangalore (IN); Shrayas Rajagopal, Bangalore (IN); Subhash A. Sharma, Bangalore (IN); Vishwas Sudhakar Nayak, Bangalore (IN); Hiti Saini, Gurgaon New Delhi (IN)

(72) Inventors: Sunil Arvindam, Bangalore (IN); Gaurav Chadha, Delhi (IN); Ashok Veilumuthu, Tirunelveli (IN); Suresh Venkatasubramaniyan, Madurai/Tamilnadu (IN); Nischal HP, Bangalore (IN); Shrayas Rajagopal, Bangalore (IN); Subhash A. Sharma, Bangalore (IN); Vishwas Sudhakar Nayak, Bangalore (IN); Hiti Saini, Gurgaon New Delhi (IN)

(21) Appl. No.: 14/456,095

(22) Filed: Aug. 11, 2014

(51) Int. Cl. G06Q 40/04

(52) U.S. Cl. CPC G06Q 40/04

(57) ABSTRACT

Implementations of the present disclosure include methods, systems, and computer-readable storage mediums for automatically configuring a user interface for interacting with an application. Actions can include receiving a request provided through a user interface of a remote device, the request including a plurality of elements including an identifier associated with a tradable asset, and a time period; in response to receiving the request, obtaining at least one transactions series relating to the tradable asset within the time period, the at least one transactions series corresponding to a trading strategy; determining a performance indicator of the trading strategy based on the transactions series; and transmitting a response to the request including content relating to the performance indicator of the trading strategy.

### BACKGROUND

In recent years, various strategies for trading assets (e.g., securities and other financial instruments) on a public exchange have been proposed. Such strategies often employ complex statistical algorithms to leverage perceived market patterns. Back-testing, forward-testing, and/or optimizing techniques can be used to evaluate and improve the performance of a trading strategy. However, the computational cost of providing performance evaluation for numerous complex algorithmic trading strategies across a wide array of variables (e.g., different assets and different historical time periods of interest) and a wide parameter space can be prohibitive to large scale implementation of a comprehensive platform. Thus, many existing platforms utilize pre-computed performance results based on a limited set of variables and parameters.

### SUMMARY

Implementations of the present disclosure include computer-implemented methods for performance evaluation of trading strategies for tradable assets such as financial instruments. In some implementations, methods include actions of: receiving a request provided through a user interface of a remote device, the request including a plurality of elements including an identifier associated with a tradable asset, and a time period; in response to receiving the request, obtaining at least one transactions series relating to the tradable asset within the time period, the at least one transactions series corresponding to a trading strategy; determining a performance indicator of the trading strategy based on the transactions series; and transmitting a response to the request including content relating to the performance indicator of the trading strategy.

These and other implementations can each optionally include one or more of the following features: Obtaining the at least one transactions series may include: submitting a query to a database, the query based on the elements of the request; and receiving, from the database, one or more transactions series responsive to the query. The elements of the request may further include one or more selection conditions relating to a desired type of transactions series. The database may include an in-memory database. The request may further include one or more evaluation parameters, and the method further may further include determining that the trading strategy corresponding to the transactions series performs according to at least one of the evaluation parameters. Determining that the trading strategy performs according to at least one of the evaluation parameters may include determining that the performance indicator meets with at least one of the evaluation parameters. Determining the performance indicator may include determining at least one of an earnings indicator, a risk indicator, and a quality indicator. Determining the earnings indicator may include comparing earnings achieved by the transactions series to passive earnings. Determining the risk indicator may include determining a standard deviation of earnings achieved by the transactions series. Determining a quality indicator may include determining at least one of: volatility, Sharpe Ratio, maximum drawdown, number of profitable trades, and rolling performance. The time period may include a back-testing period and a forward-testing period, and determining the performance indicator may include analyzing a portion of the transactions series corresponding to the back-testing period. The tradable asset may include a financial instrument. Obtaining the at least one transactions series may include: receiving trade data relating to the tradable asset, and in response to receiving the trade data, executing, at the one or more processors, the trading strategy based on the trade data to define the transactions series. Obtaining the at least one transactions series may further include: receiving, by the one or more processors, one or more strategy parameters; and in response to receiving the strategy parameters, generating the trading strategy, at the one or more processors. The at least one transactions series may include a plurality of transactions series, each of the plurality of transactions series corresponding to a respective trading strategy, and the method may further include: selecting at least two trading strategies based on a combining criteria; and combining the at least two of trading strategies to define a combined trading strategy.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Various implementations of the present disclosure advantageously facilitate performance evaluation on-demand and in real-time for complex algorithmic trading strategies based on numerous user-defined variables, conditions, and parameters. For example, options to perform complex selections of trade data across a wide strategy space can be provided together with analysis based on various quality metrics to support real-time back-testing and forward-testing. Thus, various implementations can be leveraged to provide a large scale platform for users to execute custom back-testing, forward-testing, optimization, and other evaluation techniques on unique trading strategies. Further still, in some implementations that involve and in-memory database, faster query response times can be achieved by integrating various components of the middleware and backend architecture.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system architecture in accordance with implementations of the present disclosure.

FIG. 2 depicts an example system for performance evaluation of trading strategies.

FIG. 3 depicts an example system protocol in accordance with implementations of the present disclosure.

FIG. 4 depicts an example portion of a user interface in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

### DETAILED DESCRIPTION

Implementations of the present disclosure are generally directed to systems, methods, and computer-readable media for performance evaluation of trading strategies applicable to tradable assets. In some implementations, one or more trading strategies are evaluated on demand and in real-time based on a received request that specifies at least one tradable asset. In some implementations, the request can also include a specified time period, over which selected trading strategies should be evaluated. In some implementations, the request includes one or more selection conditions and/or evaluation parameters for selecting and evaluating a trading strategy.

In various implementations, evaluating a trading strategy for a specified asset includes analyzing a series of transactions (e.g., a buy transaction, a sell transaction) associated with the trading strategy. In some examples, the transactions series is derived by applying the trading strategy to relevant trade data from the time period specified in the request. In some implementations, analyzing a transactions series includes determining one or more performance indicators associated with the transactions series. Example indicators include an earnings indicator, a risk indicator and a quality indicator. In some implementations, evaluating the trading strategy includes comparing one or more of the performance indicators to one or more of the evaluation parameters provided in the received request. In some implementations, content corresponding to the evaluated trading strategy (e.g., a performance indicator) is provided in response to the request.

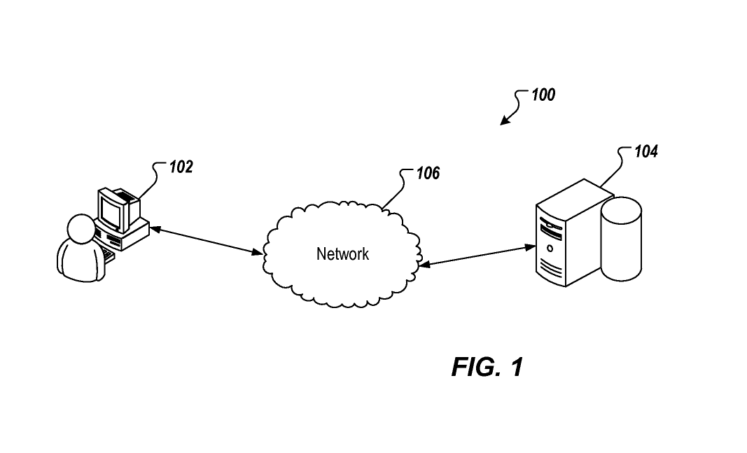

FIG. 1 depicts an example system architecture 100 in accordance with implementations of the present disclosure. The example system architecture 100 includes a client-side computing device (a client device) 102, a server-side computing device (a server device) 104 and a network 106. In general, the term “computing device” refers to any appropriate type of data processing device capable of running operating systems and application programs to perform server and/or client functions. Example computing devices can include a general-purpose personal computer (PC), a workstation, a blade server, a handheld computer, a tablet computing device, a personal digital assistant (PDA), a smartphone, or any appropriate combination of any two or more of these data processing devices or other data processing devices.

The client device 102 can communicate with the server device 104 over the network 106. The network 106 can include a large computer network, such as a local area network (LAN), a wide area network (WAN), the Internet, a cellular network, or a combination thereof connecting any number of mobile computing devices, fixed computing devices and server systems. The server device 104 can include one or more computing devices and one or more machine-readable repositories, or databases.

In some implementations, the server device 104 can provide access to a trading evaluator. As described in detail herein, in some examples, the trading evaluator is operable to implement real-time performance evaluation of trading strategies applied to tradable assets. In some implementations, a user can operate the client device 102 to interact with a web-based application hosted by the server device 104, with the web application providing access to the trading evaluator. For ease of understanding, implementations of the present disclosure may be described in view of various non-limiting examples. As one example, the web application can be provided as a stock trading application designed to facilitate buying and selling of stocks traded on a public market (e.g., the New York Stock Exchange (NYSE), the National Association of Securities Dealers Automated Quotations (NASDAQ), and the American Stock Exchange (AMEX)). However, the present disclosure is not limited to this example context. In fact, it is contemplated that the systems, methods, and computer readable media described herein can be applied to any other appropriate type of tradable assets (e.g., financial instruments, contracts, options, metals, real estate).

In some examples, the web application can be provided using one or more webpages of a website that is hosted by the server device 104. In some examples, interaction between the client device 102 and the server device 104 includes executing a web browser on the client device 102 to display the one or more webpages. In some examples, the one or more webpages include user-interface elements such as dialogue boxes and clickable buttons that enable the user to provide input to the webpage. For example, one or more graphical user interfaces (GUIs) can be displayed to the user, through which the user can interact with the web application. Other suitable techniques for providing accessibility to the trading evaluator by a client device may also be used. For example, the trading evaluator may be accessible through an application programing interface (API) from web-based or local software.

In some implementations, a transactions series includes a chronologically-organized dataset of buy and/or sell transactions determined by applying a trading strategy to relevant trade data for a particular asset. In some examples, the buy and/or sell transactions include hypothetical transactions that could be performed based on a particular trading strategy. In some implementations, a trading strategy includes one or more criterion or algorithms for signaling buy and/or sell transactions of the asset based on relevant trade data. Trade data may include any data corresponding to information suitable for influencing a decision to buy or sell tradable assets. Trade data may be directly or indirectly related to one or more assets. In the context of tradable stocks, trade data may include end-of-day data (e.g., opening price, high price, low price, closing price, trade volume), ask price, bid price, industry news data, company data (e.g., corporate accounts, earnings figures, corporate actions), stock split data, stock option data, stock rating news data (e.g., stock ratings published by investment research firms), macroeconomic data (e.g., interest rates, inflation figures), and technical indicators (e.g., moving average, momentum, relative strength index, accumulation/distribution index).

A simple example stock trading strategy may include the following two criterion: (A) if bid price is greater than X, then sell Y shares; and (B) if ask price is less than X, then buy Y shares, where X is a predetermined stock price and Y is a predetermined number of shares. Of course, significantly more complex criteria and algorithms (e.g., momentum trading, trend following, cyclical trading, and arbitrage algorithms) are contemplated within the scope of the present disclosure. Further, while various examples are described as utilizing trading strategies focused on a singular asset, it is contemplated that trading strategies focused on groups of multiple assets can also be implemented. A multi-asset trading strategy may produce multiple transactions series.

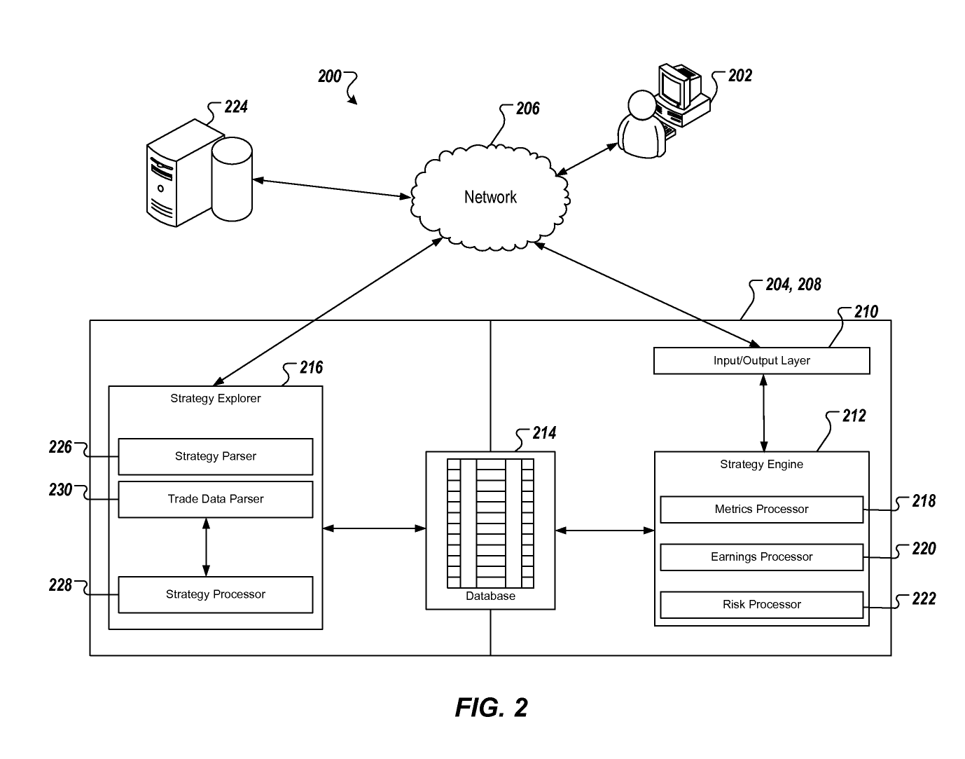

FIG. 2 depicts an example system 200 for real-time performance evaluation of trading strategies. As described above with respect to the system architecture 100 of FIG. 1, the system 200 includes a client device 202 communicating with a server device 204 over a network 206. In this example, the server device 204 provides accessibility to the trading evaluator 208, e.g., through a web application or an API. In this example, the trading evaluator 208 includes an input/output layer 210, a strategy engine 212, a database 214, and a strategy explorer 216.

The input/output layer 210 receives requests from the client device 202 for performance evaluation of one or more trading strategies with respect to one or more assets (e.g., stocks) through the network 206, and provides an appropriate response to the client device 202 in real-time. The strategy engine 212 queries the database 214 based on the request for one or more transactions series corresponding to respective trading strategies involving the specified asset(s). The strategy engine 212 includes an earnings processor 218, a risk processor 220, and an earnings processor 222 for analyzing received transactions series from the database 214. The strategy engine 212 provides selected content to the input/output layer 210 for the response to the client device 202 based on analysis of the transactions series. The strategy explorer 216 receives trade data from an external source 224 through the network 206 and applies multiple trading strategies to the trade data to provide multiple transactions series. In some examples, each of the transactions series corresponds to a respective trading strategy involving a respective asset. The transactions series and the trade data are communicated and stored at the database 214 for retrieval by the strategy engine 212.

In some implementations, a request from the client device 202 may include various elements of content identifiable by a parser of the input/output layer 210. Parsed elements of the request can be referenced in the query from the strategy engine 212 to the database 214 to retrieve relevant transactions series. In some examples, elements of the request include a stock identifier and a time period. In some implementations, the stock identifier includes a name, ticker symbol, or code corresponding to a tradable stock. In some implementations, the time period includes a back-testing time period and/or a forward-testing time period expressed in calendar date format. In some examples, only the back-testing time period is used for selection and evaluation of the trading strategy/transactions series. In some examples, both the back-testing and forward-testing time periods are used.

In some implementations, elements of the request further include one or more selection conditions and/or evaluation parameters relating to trading strategies desired by the user. Selection conditions and/or evaluation parameters may also be directly submitted to the strategy engine through a user interface. Selection conditions may provide constraints for query-retrieval by the strategy engine 212 of one or more relevant transactions series from the database 214. Thus, in some examples, only those transactions series that satisfy the specified selection conditions are retrieved from the database 214 by the strategy engine 212. Evaluation parameters may be used by the strategy engine 212 to provide selected content for the response. For example, the strategy engine 212 may provide selected content for the response that corresponds to trading strategies that, over the specified time period, perform within the evaluation parameters. In some examples, the selection conditions and evaluation parameters are applied to the transactions series in connection with a back-testing time period specified in the request.

In some implementations, selection conditions for trading strategies may include a maximum or minimum amount of transactions in the corresponding transactions series (e.g., X number of total transactions over the time period or X number of transactions per week over the time period). In some implementations, selection conditions for trading strategies may include a maximum or minimum transaction value (e.g., X amount of shares per transaction or X percent of total shares per transaction). In some implementations, suitable evaluation parameters may include an earnings parameter, a risk parameter, and a quality parameter that can be compared to corresponding performance indicators of a trading strategy. In some examples, the evaluation parameters can be expressed numerically as absolute values, ratios, or percentages.

In some implementations, an earnings indicator for a trading strategy is determined at the earnings processor 218 by determining earnings achieved according to the corresponding transactions series. In some examples, determining an earnings indicator includes determining a total amount of earnings over a specified time period. In some examples, determining an earnings indicator includes comparing earnings from the transactions series to passive earnings. In some examples, passive earnings may include earnings achieved without implementation of any trading strategy (e.g., earnings from ownership of the specified stock). Thus, the earnings indicator may provide an indication of whether, and to what degree, the trading strategy outperformed a passive ownership strategy.

In some implementations, a risk indicator for the trading strategy is determined at the risk processor 220 by assessing the volatility of earnings achieved according to the transactions series. In some examples, a statistical technique for determining the volatility of earnings includes determining a standard deviation of earnings achieved by the transactions series. In some examples, determining a risk indicator may further include comparing the standard deviation of earnings achieved by the transactions series to a standard deviation of a stock index (e.g., the American S&P 500) over the specified time series. In some implementations, a quality indicator for a particular trading strategy is determined at the metrics processor 222. In some examples, the quality indicator can include one or more of: volatility, Sharpe Ratio, maximum drawdown, number of profitable trades, and rolling performance. In some examples, the quality indicator includes a user-defined value. The earnings indicator, the risk indicator, and/or the quality indicator can be compared to a corresponding evaluation parameter. In some implementations, output associated with trading strategies that meet with one or more of the evaluation parameters is provided to the input/output layer 210 by the strategy engine 212 to be included as content in a response to the client device 202.

The strategy engine 212 may selectively provide various types of content associated with a trading strategy to the input/output layer 210. In some examples, the selected content can include one or more of the performance indicators of the trading strategy—e.g., the earnings indicator, the risk indicator, and the quality indicator. In some examples, the selected content can include the transactions series corresponding to the trading strategy. In some examples, the selected content can include structured earnings data associated with the transactions series (e.g., chronologically-organized earnings data). In some examples, the selected content can include a graph of the earnings data. In some examples, the selected content can include trade data associated with one or more assets specified in the request.

As noted above, the strategy explorer 216 receives trade data from an external source 224 and applies multiple trading strategies to the trade data to provide multiple transactions series. In some examples, each of the transactions series corresponds to a specific trading strategy. The trade data can be communicated to the strategy explorer 216 over the network 206 in a continuous data stream or in discrete data packets. In some implementations, the external source 224 is associated with a third party financial data provider or a securities exchange. In some examples, the strategy explorer 216 can process incoming trade data to produce additional trade data. As one example, the strategy explorer 216 may receive price data associated with an asset from the external source 224 and process the price data to produce a momentum technical indicator associated with the asset.

In some implementations, the trading strategies can be defined by one or more strategy parameters. In some examples, the strategy parameters can be provided to the strategy explorer 216 from the external source 224 or from another external source. In some examples, the strategy parameters are directly submitted to the strategy explorer 216 through a user interface. As one non-limiting example, a crossover strategy may be defined by one or more strategy parameters. According to the crossover strategy, the simple moving average (SMA) of a fast time window is compared to the SMA of a slow time window; a Buy decision is made when the SMA of fast time window crosses the SMA of the slow time window from below; and a Sell decision is made when the SMA of the fast time window cross the SMA of the slow time window from above. In this example, a first strategy parameter may set the length of the fast time window (e.g., 50 days) and a second strategy parameter may set the length of the slow time window (e.g., 200 days).

Strategy parameters provided to the strategy explorer 216 are received and parsed at a strategy parser 226. The strategy parser 226 provides the parsed strategy parameters to a strategy processor 228. Trade data provided to the strategy explorer 216 is received at a trade data parser 230. The trade data parser 230 parses the trade data into its constituent elements and provides the parsed trade data to the strategy processor 228. The strategy processor 228 provides multiple trading strategies based on the parsed strategy parameters, and applies the trading strategies to the parsed trade data to provide multiple transactions series. The transactions series are communicated from the strategy explorer to the database 214. In some examples, the strategy processor 228 updates existing transactions series stored at the database 214 in response to receiving additional relevant trade data. In some examples, the trade data itself and/or the strategy parameters can also be communicated to the database 214.

In some implementations, the database 214 is provided in the form an in-memory computing device operable to store and analyze trade data, transactions series, and strategy parameters in random access memory (RAM). Thus, it is contemplated that one or more operations described above in connection with the strategy processor 228 may alternatively be executed by the database 214. For example, the database 214 may be operable to update transactions series based on new relevant trade data.

In some implementations, the trade evaluator 208 is further operable to combine one or more evaluated trading strategies. For example, the trade evaluator 208 may initiate a process to combine trading strategies in response to a request (e.g., a user request), or automatically in response to a determination that the evaluated trading strategies did not perform within the performance parameters. In some examples, the strategy engine 212 may select two or more trading strategies for combination in accordance with one or more combining criterion. As one example, the combining criterion may detect trading strategies associated with one or more performance indicators that are above a predetermined threshold. As another example, the combining criterion may detect trading strategies associated with multiple performance indicators that meet with multiple evaluation parameters. Any suitable combining criterion can be used without departing from the scope of the present disclosure. In some implementations, the strategy engine 212 combines multiple trading strategies according to a combining algorithm according to one or more of the following example techniques: signal weighting, entropy-pooling, and predictive modeling. In some implementations, strategy parameters for the combined trading strategy are provided to the strategy explorer 216 for producing a transactions series to be stored in the database 214 and analyzed by the strategy engine 212.

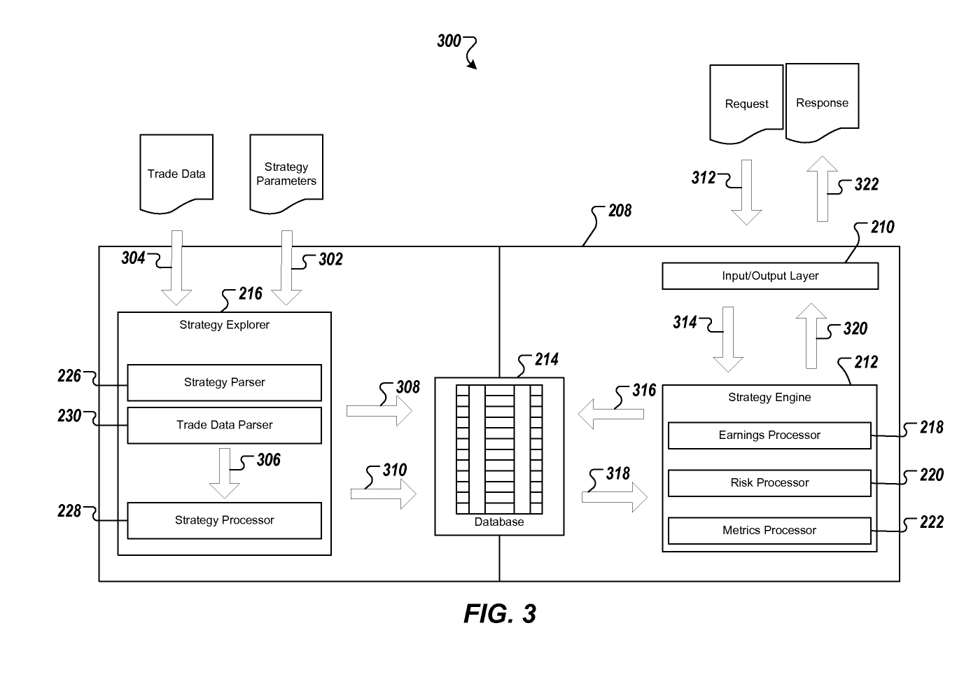

FIG. 3 depicts an example system protocol 300 in accordance with implementations of the present disclosure. In the example of FIG. 3, strategy parameters are provided (302) to the strategy explorer 216 and received at the strategy parser 226. Trade data is provided (304) to the strategy explorer 216 and received at the trade data parser (230). Parsed strategy parameters and parsed trade data are provided (306) to the strategy processor 228. In some examples, the strategy processor 228 provides multiple trading strategies based on the strategy parameters, and applies the trading strategies to the trade data to produce multiple transactions series. In some implementations, each of the transactions series corresponds to a respective trading strategy and a respective tradable asset. The transactions series are communicated (310) to the database 214. In some examples, the trade data and/or the strategy parameters are also communicated (308) to the database 214.

A request for performance evaluation of trading strategies communicated to the trade evaluator 208 is received (312) at the input/output layer 210. The input/output layer provides (314) the request to the strategy engine 212. The strategy engine 212 queries (316) the database 214 for relevant transactions series based on an asset identifier and time period specified in the request. In some implementations, the query submitted by the strategy engine 212 to the database 214 includes one or more selection conditions to isolate transactions series corresponding to desired trading strategies. One or more transactions series responsive to the query are provided (318) to the strategy engine 212.

In some implementations, the strategy engine 212 analyzes the transactions series to evaluate the corresponding trading strategies. In some implementations, the strategy engine 212 determines one or more performance indicators (e.g., an earnings indicator, a risk indicator, and a quality indicator) and compares the performance indicators to one or more evaluation parameters. In some examples, the strategy engine 212 determines that a strategy performed within the evaluation parameters if one or more performance indicators based on the corresponding transactions series compare favorably to one or more of the evaluation parameters. The strategy engine 212 provides (320) selected content associated with one or more evaluated trading strategies to the input/output layer 210. In some examples, the content is selected based on a determination that the one or more trading strategies performed within the evaluation parameters. For example, the selected content may include one or more of the performance indicators.

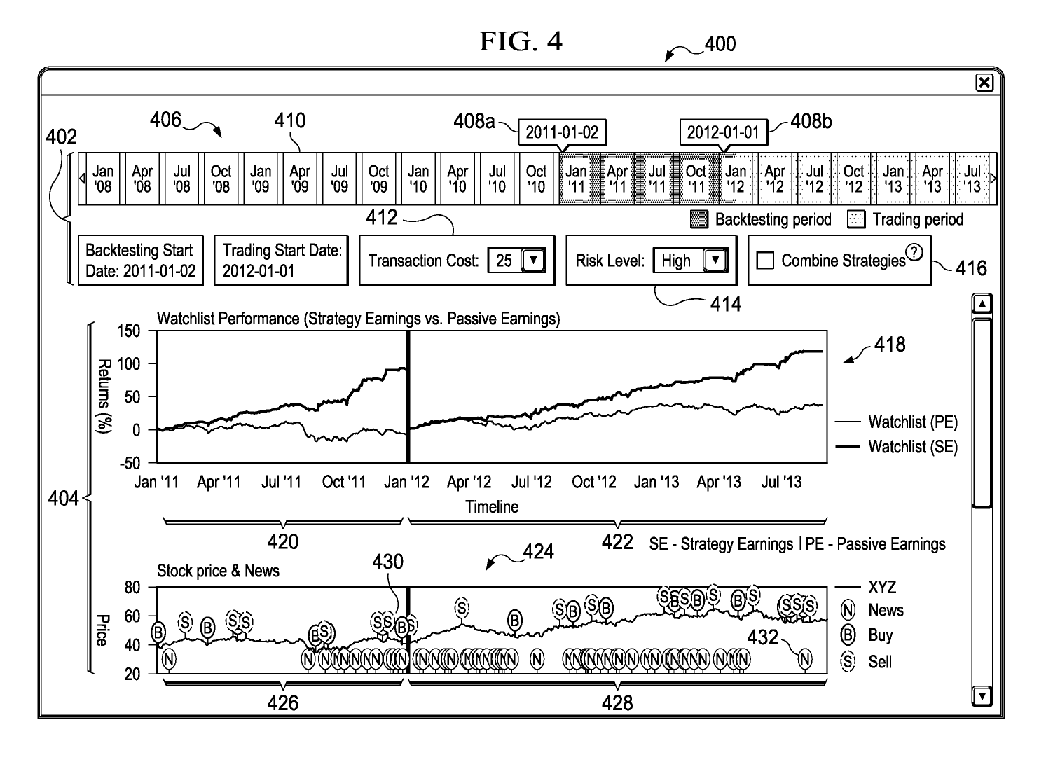

FIG. 4 is a screenshot depicting a portion of an example GUI 400 in accordance with implementations of the present disclosure. In some implementations, the GUI 400 can be displayed to a user through a webpage of a web application communicating with the trading evaluator 208 through the network 206. In some implementations, the GUI 400 includes a collection of UI elements that provide input and output functionality, for example. In some examples, input functionality enables users to manipulate the web application, while output functionality enables the web application to express the effect(s) of the users' manipulation. In some examples, UI elements can include textual and/or graphical UI elements. Textual UI elements can include text-based interfaces (e.g., text boxes) and windows for displaying text. Graphical UI elements can include selectable controls (e.g., menu bars, toolbars, buttons, drop down lists, sliders, spinners) and windows for displaying still or moving graphics. A user can interact with the UI elements, for example, by mouse click, mouseover, scrolling, keyboard navigation or screen touch, and/or interfacing with a textual UI element by scrolling through or entering text. The specific UI elements described in context of the GUI 400 are not intended to be limiting, but provide an example input and output functionality to facilitate user interaction with a trading evaluator via the GUI of web-based or local software.

In some implementations, the GUI 400 includes an options region 402 and a display region 404. In some examples, the options region 402 includes multiple control elements for establishing a time period, at least one selection condition, and at least one evaluation parameter to be included in a request to the strategy engine 212. In some examples, the display region 404 includes one or more displays for presenting content selected by the strategy engine 212 that relates to one or more evaluated trading strategies.

In this example, the options region 402 includes a slider element 406 for establishing a time period of the request. The slider element 406 includes a pair of movable indicators 408a and 408b and a scale 410. The scale 410 is a timeline ranging from a historical date to a present date. The first indicator 408a is movable along the scale 410 to establish a back-testing start date. The second indicator 408b is movable along the scale 410 to establish a trading start date (e.g., a forward-testing start date). In some examples, the time period included in the request received by the strategy engine 212 includes the back-testing start data and the trading start date indicated via the slider element 406. In some examples, the query submitted to the database 214 includes a time range between the back-testing start date and the present date, so that the retrieved transactions series spans both the back-testing time period and the trading time period.

The options region 402 further includes a first drop down list 412 for establishing a transaction-cost selection condition to be included in the request, and a second drop down list 414 for establishing a risk-level parameter to be included in the request. In some examples, the transaction costs selection condition corresponds to a maximum number of transactions included in the transactions series of a particular strategy. In this example, a user has selected a maximum of twenty-five transactions during a back-testing period. In some examples, the risk-level parameter corresponds to a maximum amount of variance in the earnings achieved by the transactions series of a particular strategy. In this example, the user has selected a “high” level of earnings variance (the qualitative indicator “high” may correspond to an appropriate numerical value of variance). The options region 402 still further includes a check box element 416 for initiating a combination of relevant trading strategies.

The display region 404 includes a strategy performance graph 418 for a stock watchlist (e.g., a group of multiple stocks). In some examples, the strategy performance graph includes content relating to a performance indicator (e.g., an earnings indicator) of a trading strategy. In this example, the strategy performance graph 418 illustrates a chronological comparison between earnings (or returns) achieved by a particular trading strategy and earnings achieved by a passive strategy. The strategy performance graph 418 includes a back-testing portion 420 corresponding to a time range between the back-testing start date and the trading start date, and a trading portion 422 corresponding to a time range between the trading start date and the present date. The display region 404 further includes a stock price graph 424 aligned with the strategy performance graph 418. The stock price graph 424 illustrates a chronological series of stock prices for a particular stock in the watchlist. The stock price graph 424 also includes a back-testing portion 426 and a trading portion 428. In this example, the price graph 424 includes a set of indicators 430 representing buy and sell transactions determined by the underlying trading strategy, and a set of indicators 432 representing news items included in the underlying trade data.

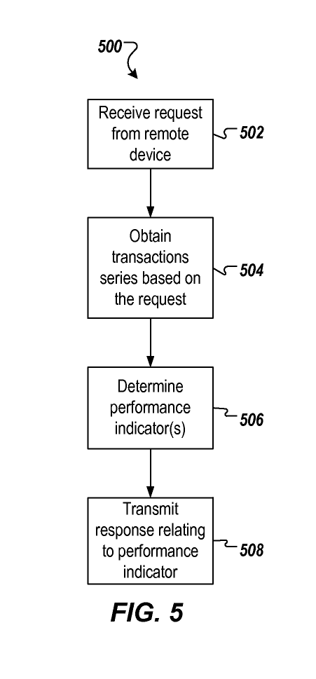

FIG. 5 depicts an example process 500 that can be executed in accordance with implementations of the present disclosure. In some implementations, the example process 500 can be realized using one or more computer-executable programs (e.g., a browser, a web application, a mobile application) executed using one or more computing devices (e.g., a client-side computing device, a server-side computing device).

According to the example process 500, a request is received (502). The request can include a plurality of elements, including an identifier associated with a tradable asset (e.g., a financial instrument) and a time period. In some implementations, the time period includes a back-testing period and a forward-testing period. In some implementations, the request further includes one or more selection conditions and/or or one or more evaluation parameters. In response to receiving the request, at least one transactions series relating to the tradable asset and within the time period specified in the request is obtained (504). The transactions series corresponds to a trading strategy. In some implementations, obtaining the transactions series includes submitting a query based on the elements of the request to a database (e.g., an in-memory database), and receiving the transactions series from the database in response to the query. In some implementations, obtaining the transactions series includes receiving trade data relating to the tradable asset, and executing the trading strategy based on the trade data to define the transactions series. The transactions series can be stored in the database. In some implementations, the trading strategy is generated based on one or more received strategy parameters.

A performance indicator of the trading strategy is determined (506) based on the transactions series. In some implementations, the performance indicator includes at least one of an earnings indicator, a risk indictor, and a quality indicator. In some implementations, the performance indicator is determined based on a portion of the transactions series corresponding to the back-testing period specified in the request. In some implementations, the performance indicator is compared to an evaluation parameter included in the request to determine whether the trading strategy performs according to the evaluation parameter. A response to the request is transmitted (508) including content relating to the performance indicator of the trading strategy.

Implementations of the present disclosure provide one or more technical advantages. In particular, various implementations of the present disclosure advantageously facilitate performance evaluation on-demand and in real-time for complex algorithmic trading strategies based on numerous user-defined variables, conditions, and parameters. For example, options to perform complex selections of trade data across a wide strategy space can be provided together with analysis based on various quality metrics to support real-time back-testing and forward-testing. Thus, various implementations can be leveraged to provide a large scale platform for users to execute custom back-testing, forward-testing, optimization, and other evaluation techniques on unique trading strategies. Further still, in some implementations that involve and in-memory database, faster query response times can be achieved by integrating various components of the middleware and backend architecture.

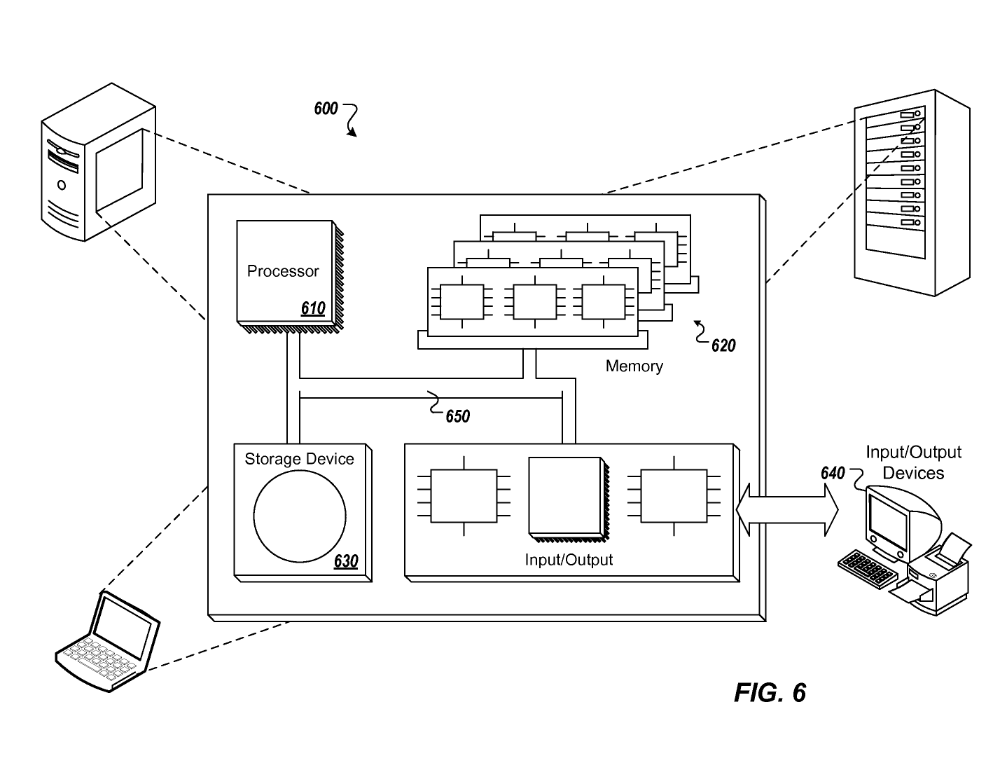

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. Each of the components 610, 620, 630 and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit. The storage device 630 is capable of providing mass storage for the system 600. In one implementation, the storage device 630 is a computer-readable medium. In various different implementations, the storage device 630 may be a floppy disk device, a hard disk device, an optical disk device, or a tape device. The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for performance evaluation of trading strategies, the method being executed using one or more processors and comprising:
receiving, by the one or more processors, a request provided through a user interface of a remote device, the request comprising a plurality of elements including:
an identifier associated with a tradable asset; and
a time period;
in response to receiving the request, obtaining, by the one or more processors, at least one transactions series relating to the tradable asset within the time period, the at least one transactions series corresponding to a trading strategy;
determining, by the one or more processors, a performance indicator of the trading strategy based on the transactions series; and
transmitting, by the one or more processors, a response to the request including content relating to the performance indicator of the trading strategy.

2. The method of claim 1, wherein obtaining the at least one transactions series comprises:
submitting a query to a database, the query based on the elements of the request; and
receiving, from the database, one or more transactions series responsive to the query.

3. The method of claim 2, wherein the elements of the request further include one or more selection conditions relating to a desired type of transactions series.

4. The method of claim 2, wherein the database comprises an in-memory database.

5. The method of claim 1, wherein the request further includes one or more evaluation parameters, and wherein the method further comprises determining that the trading strategy corresponding to the transactions series performs according to at least one of the evaluation parameters.

6. The method of claim 5, wherein determining that the trading strategy performs according to at least one of the evaluation parameters comprises determining that the performance indicator meets with at least one of the evaluation parameters.

7. The method of claim 1, wherein determining the performance indicator includes determining at least one of an earnings indicator, a risk indicator, and a quality indicator.

8. The method of claim 7, wherein determining the earnings indicator comprises comparing earnings achieved by the transactions series to passive earnings.

9. The method of claim 7, wherein determining the risk indicator comprises determining a standard deviation of earnings achieved by the transactions series.

10. The method of claim 7, wherein determining a quality indicator comprises determining at least one of: volatility, Sharpe Ratio, maximum drawdown, number of profitable trades, and rolling performance.

11. The method of claim 1, wherein the time period comprises a back-testing period and a forward-testing period, and wherein determining the performance indicator comprises analyzing a portion of the transactions series corresponding to the back-testing period.

12. The method of claim 1, wherein the tradable asset comprises a financial instrument.

13. The method of claim 1, wherein obtaining the at least one transactions series comprises:
receiving, by the one or more processors, trade data relating to the tradable asset; and
in response to receiving the trade data, executing, at the one or more processors, the trading strategy based on the trade data to define the transactions series.

14. The method of claim 13, wherein obtaining the at least one transactions series further comprises:
receiving, by the one or more processors, one or more strategy parameters; and
in response to receiving the strategy parameters, generating the trading strategy, at the one or more processors.

15. The method of claim 1, wherein the at least one transactions series comprises a plurality of transactions series, each of the plurality of transactions series corresponding to a respective trading strategy, and wherein the method further comprises:
selecting at least two trading strategies based on a combining criteria; and
combining the at least two of trading strategies to define a combined trading strategy.

16. A non-transitory computer-readable storage medium coupled to one or more processors and having instructions stored thereon which, when executed by the one or more processors, cause the one or more processors to perform operations for performance evaluation of trading strategies, the operations comprising:
receiving, by the one or more processors, a request provided through a user interface of a remote device, the request comprising a plurality of elements including:
an identifier associated with a tradable asset; and
a time period;
in response to receiving the request, obtaining, by the one or more processors, at least one transactions series relating to the tradable asset within the time period, the at least one transactions series corresponding to a trading strategy;
determining, by the one or more processors, a performance indicator of the trading strategy based on the transactions series; and
transmitting, by the one or more processors, a response to the request including content relating to the performance indicator of the trading strategy.

17. A system, comprising:
a client-side computing device including one or more processors; and
a computer-readable storage device coupled to the client-side computing device and having instructions stored thereon which, when executed by the client-side computing device, cause the client-side computing device to perform operations for performance evaluation of trading strategies, the operations comprising:
receiving, by the one or more processors, a request provided through a user interface of a remote device, the request comprising a plurality of elements including:
an identifier associated with a tradable asset; and
a time period;
in response to receiving the request, obtaining, by the one or more processors, at least one transactions series relating to the tradable asset within the time period, the at least one transactions series corresponding to a trading strategy;
determining, by the one or more processors, a performance indicator of the trading strategy based on the transactions series; and
transmitting, by the one or more processors, a response to the request including content relating to the performance indicator of the trading strategy.
